(19) United States
(12) Patent Application Publication
(10) Pub. No.: US 2020/0127455 A1
(43) Pub. Date: Apr. 23, 2020

(54) Device and Method for Controlling DC Bus Ripple

(71) Applicant: Technology Innovation Momentum Fund (Israel) Limited Partnership, Tel Aviv (IL)

(72) Inventors: Shaul Ozeri, Tel Aviv (IL); George Weiss, Rishon Leziyon (IL); Jun Lin, Yanzhou (CN)

(21) Appl. No.: 16/578,466

(22) Filed: Sep. 23, 2019

Related U.S. Application Data
(60) Provisional application No. 62/748,460, filed on Oct. 21, 2018.

(51) Int. Cl. H02J 1/02; H02M 3/158; H02M 1/14

(52) U.S. Cl. CPC H02J 1/02; H02M 2001/0048; H02M 1/14; H02M 3/1582

(57) ABSTRACT

An apparatus for controlling ripple voltage on a bus includes a switched power converter and a control circuit. The switched power converter includes a pair of terminals for connection between the bus and a ground, a buffer capacitor, an inductor, and switching circuitry coupled to the buffer capacitor and the inductor. The switching circuitry is configured to control a voltage between the terminals while a charge on the buffer capacitor varies over a predefined range in response to a current flowing through the terminals. The control circuit is configured to adjust the voltage between the terminals by controlling the switching circuitry while maintaining bipolar current flow through the inductor in all working conditions of DC voltage and power flow.

### CROSS-REFERENCE TO RELATED APPLICATIONS

This application claims the benefit of U.S. Provisional Patent Application 62/748,460, filed Oct. 21, 2018, whose disclosure is incorporated herein by reference.

### FIELD OF THE INVENTION

This invention relates generally to power-electronics systems and devices, and particularly DC voltage filtering.

### BACKGROUND OF THE INVENTION

When a power source supplies a load with DC voltage and the current that the load draws comprises a large AC component (e.g., the load is a DC to AC inverter) the voltage across the load may fluctuate. Voltage fluctuations may also be contributed by the power source itself (for example, due to a power-factor correction stage).

The traditional way to suppress such fluctuations is to connect a large capacitor, typically an electrolytic capacitor or a supercapacitor, in parallel with the load. Such filtering capacitors are commonly encountered, for example, on the DC bus in photovoltaic systems, wind power generators, sub-modules of modular multilevel converters (MMC), electric vehicles, power factor compensators (PFC), uninterruptible power supplies, and power supplies for flicker-free LED lighting. Large capacitors of this sort, however, are bulky, expensive and have a short working life.

PCT International Publication WO 2019/073353, whose disclosure is incorporated herein by reference, describes circuits that add “plug-and-play” capability to the VIC, meaning that the VIC can be packaged and deployed in a wide range of systems as an independent module.

PCT International Publication WO 2015/019344, whose disclosure is incorporated herein by reference, describes a virtual infinite capacitor (VIC)—a switched power circuit containing switches, an inductor, and two small capacitors, including a charge buffer capacitor. Within a designated operating range, the VIC emulates the behavior of very large capacitors by maintaining a constant voltage notwithstanding changes in the charge on the buffer capacitor.

### SUMMARY OF THE INVENTION

An embodiment of the present invention that is described herein provides an apparatus for controlling ripple voltage on a bus, including a switched power converter and a control circuit. The switched power converter includes a pair of terminals for connection between the bus and a ground, a buffer capacitor, an inductor, and switching circuitry coupled to the buffer capacitor and the inductor. The switching circuitry is configured to control a voltage between the terminals while a charge on the buffer capacitor varies over a predefined range in response to a current flowing through the terminals. The control circuit is configured to adjust the voltage between the terminals by controlling the switching circuitry while maintaining bipolar current flow through the inductor in all working conditions of DC voltage and power flow.

In some embodiments, the control circuit is configured to control the average current drawn by the power converter per switching cycle by adding a low-frequency voltage reference to both positive and negative current thresholds ipk+ and ipk− that are applied to the current flow through the inductor. In an embodiment, the control circuit is configured to adjust a difference Δi between ipk+ and ipk− so as to reduce power loss in the power converter for low power flow conditions. In another embodiment, the control circuit is configured to adjust a difference Δi between ipk+ and ipk− so as to control a variation range of a switching frequency of the power converter. In an embodiment, the switching circuitry is configured to operate in both buck and boost modes, and the control circuit is configured to select an operating mode of the switching circuitry responsively to a level of the voltage, so as to maintain the current flow through the inductor within a desired range.

In some embodiments, the inductor includes a core having a plurality of windings arranged thereon in series so as to cancel a flux of a magnetic field within the core. The apparatus may further include a Hall effect sensor coupled to the core and configured to output a signal in response the magnetic field, and the control circuit may be configured to estimate and control the current flow through the inductor responsively to the signal.

There is additionally provided, in accordance with an embodiment of the present invention, an apparatus for controlling ripple voltage on a bus, including a switched power converter and a control circuit. The switched power converter includes a pair of terminals for connection between the bus and a ground, a buffer capacitor, and switching circuitry coupled to the buffer capacitor. The switching circuitry is configured to control a voltage between the terminals while a charge on the buffer capacitor varies over a predefined range in response to a current flowing through the terminals. The control circuit is configured to adjust the voltage between the terminals by controlling the switching circuitry while maintaining a DC voltage level on the buffer capacitor sufficient so that a total voltage across the buffer capacitor remains in a positive range while an AC component of the total voltage varies in order to cancel a ripple on the bus.

In an embodiment, the control circuit is configured to operate the switching circuitry so as to connect the buffer capacitor to the bus until the buffer capacitor has charged to the sufficient DC voltage level. There is further provided, in accordance with an embodiment of the present invention, an apparatus for controlling ripple voltage on a bus, including a switched power converter and a control circuit. The switched power converter includes a pair of terminals for connection between the bus and a ground, a floating buffer capacitor not coupled to ground, an inductor, and switching circuitry coupled to the buffer capacitor and the inductor. The control circuit is configured to adjust the voltage between the terminals by controlling the switching circuitry.

In an embodiment, the floating buffer capacitor is coupled directly to a first terminal of the inductor, and through a switch of the switching circuitry to a second terminal of the inductor.

There is also provided, in accordance with an embodiment of the present invention, an apparatus for controlling ripple voltage on a bus, including a switched power converter, a control circuit, and an auxiliary power supply. The switched power converter includes a pair of terminals for connection between the bus and a ground, a buffer capacitor, and switching circuitry coupled to the buffer capacitor. The switching circuitry is configured to control a voltage between the terminals while a charge on the buffer capacitor varies over a predefined range in response to a current flowing through the terminals. The control circuit is configured to adjust the voltage between the terminals by controlling the switching circuitry. The auxiliary power supply includes a linear regulator, which is connected to the bus and configured to reduce the DC voltage on the bus to a predefined intermediate voltage, and a switching regulator, which is configured to convert the intermediate voltage to a predefined low DC voltage for powering the switching circuitry and the control circuit.

The present invention will be more fully understood from the following detailed description of the embodiments thereof, taken together with the drawings in which:

### BRIEF DESCRIPTION OF THE DRAWINGS

FIG. 1 is a block diagram that schematically illustrates the structure of a Virtual Infinite Capacitance (VIC) system for DC bus filtering, according to embodiments of the present invention;

FIG. 2 is a waveform that schematically illustrates the typical voltage across the buffer capacitor Cs in accordance to embodiments of the present invention;

FIG. 3 is a circuit diagram that schematically illustrates a boost-type power stage of a VIC, according to embodiments of the present invention;

FIG. 4 is a schematic illustration of the waveform of the inductor bipolar current, according to an embodiment of the present invention;

FIG. 5 is a graph that schematically illustrates the controlled peak to peak difference of inductor currents, according to an embodiment of the present invention;

FIG. 6 is a circuit diagram that schematically illustrates a buck-type power stage of a VIC, according to embodiments of the present invention;

FIGS. 7A and 7B are schematic illustrations of the inductor bipolar current generated by the power stage, according to an embodiment of the present invention;

FIG. 8 is a schematic diagram of a Combined Boost-Buck power stage of a VIC, according to an embodiment of the present invention;

FIG. 9 is a schematic diagram of a Floating Buffer-Capacitor power stage of a VIC, according to an embodiment of the present invention;

FIG. 10A is a schematic illustration of the current path of a Floating Buffer-Capacitor power stage in a first switching state, according to embodiments of the present invention;

FIG. 10B is a schematic illustration of the current path of a Floating Buffer-Capacitor power stage in a second switching state, according to embodiments of the present invention;

FIG. 10C is a schematic illustration of the current path of a Floating Buffer-Capacitor power stage in a third switching state, according to embodiments of the present invention;

FIG. 10D is a schematic illustration of the current path of a Floating Buffer-Capacitor power stage in a fourth switching state, according to embodiments of the present invention;

FIG. 11 is a diagram that schematically illustrates a cross-section view of an inductor with two winding groups and core flux cancellation, according to an embodiment of the present invention;

FIG. 12 is a diagram that schematically illustrates a cross-section view of an inductor with eight winding groups and core flux cancellation, according to an embodiment of the present invention; and

FIG. 13 is a block diagram that schematically shows the structure of an optional auxiliary power supply, according to embodiments of the present invention.

### DETAILED DESCRIPTION OF EMBODIMENTS

### Overview

Embodiments according to the present invention that are disclosed herein relate to a two-terminal Plug-and-Play (PnP) Virtual Infinite Capacitor (VIC) power circuit and its unique control scheme. In embodiments, a wide range of high DC bus voltages may be handled; e.g. −300V −1000V. Such large DC voltage variations are common in photovoltaic flexible length panel strings, DC buses of wind turbines, electric vehicle chargers and other power electronic applications.

Some of the disclosed embodiments provide improved circuits and control schemes for PnP VICs that reduce the ripple of power busses, enhancing their performance and versatility. These embodiments are useful, for example, in enabling the PnP VIC to operate at high power density and high voltages.

According to embodiments, the VIC comprises a Power Stage and a Control Stage; the Power stage circuitry, which regulates the voltage on the bus, comprises an inductor, a buffer capacitor and a switching circuit; the Control Stage controls the switching stage so as to minimize the ripple voltage of the power bus.

In embodiments according to the present invention, the VIC comprises a current sensor that senses the current through the inductor, and an Iripple sensor that senses the ripple current of the power bus (the residual ripple current, after the regulation of the VIC). The switching stage of the VIC is configured to generate bipolar current through the inductor, so as to minimize the residual ripple current, and, thus, maintain good voltage regulation of the power bus.

In some embodiments, the control stage generates a Low-Frequency Reference (LFR) current and controls the current through the inductor to oscillate at high frequency (relative to the LFR frequency) between LFR minus a threshold (R) to LFR plus the threshold, so that the average current through the inductor equals LFR.

In some embodiments the value of R is fixed; in other embodiments, the value of R may change according to the average ripple current—when the ripple is low, R may be small, increasing the efficiency of the VIC.

We will sometimes refer hereinbelow to the circuitry of the power stage as power circuit (or power circuitry), and to the circuitry of the control stage as control circuit (or control circuitry).

Embodiments that are disclosed hereinbelow comprise a BOOST power circuit, a BUCK power circuit, a combined BOOST-BUCK power circuit, and a floating-buffer-capacitor circuit (described below). The techniques that are disclosed, however, may be applicable to other suitable types of power circuits.

According to some embodiments, the power and control circuits maintain zero voltage soft switching in a wide range of working conditions. This feature is required in order to achieve high power density of the VIC, and to lower its power loss.

In some embodiments of the present invention, a power stage with a floating buffer capacitor is disclosed, wherein the buffer capacitor is not referenced to the common ground; according to embodiments, a floating buffer capacitor power circuit supports a wider range of input voltages.

According to embodiments, the inductor current of power stages may contain a large AC component. In some embodiments, to minimize losses due to hysteresis and eddy currents and to reduce the size of the inductor, the inductor is distributed to smaller inductors connected in series or in parallel in the same core.

In an example embodiment, a gap is used to limit the flux, and flux cancellation is obtained by opposite directions of two groups of windings on two legs of the inductor.

In another example embodiment, eight inductor portions are wired separately on eight legs of a common core, wherein the direction of the winding of each leg is the reverse of the direction of the winding of adjacent legs. All legs share a common return leg, and the flux in the return leg is close to zero.

Another embodiment of the present invention that is disclosed herein provides an efficient DC to DC converter, which generates the supply voltage of the control unit of the VIC. According to embodiments of the present invention, the control unit's supply voltage is low (e.g., 12V), and, for a two-terminal VIC, must be generated from the bus power. However, when the power bus voltage is high (e.g., 1000V), a switching DC to DC converter may be expensive. On the other hand, the power efficiency of linear converters is, by definition, no more the Vout/Vin (1.2% to convert from 1000V to 12V). In embodiments according to the present invention, a hybrid DC to DC converter may be used, with a linear first stage (e.g., reducing the voltage from a value between 500V to 1000V, to 500V) followed by a high-efficiency DC to DC converter that further reduces the voltage from 500V to 12V. The overall power efficiency of the converter may be close to the efficiency of the linear regulator.

### System Description

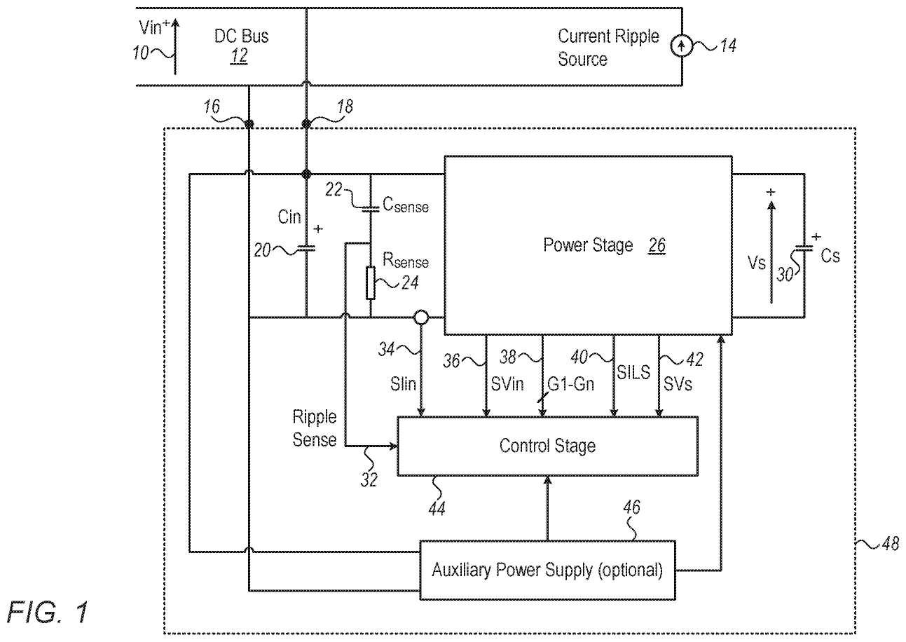

FIG. 1 is a block diagram 48 that schematically illustrates the structure of a Virtual Infinite Capacitance (VIC) system for DC bus filtering, according to embodiments of the present invention. The VIC is connected through a negative terminal 16 and a positive terminal 18 to a DC bus 12.

DC bus 12 is connected to a DC source 10 that feeds a load 14. Load 14 may be, for example, a DC to AC inverter. The load may draw also AC current from the DC source. VIC 48 comprises a switching power stage 26 and a control stage 44.

The VIC senses the AC ripple on DC bus 12 using an R-C network, which comprises a capacitor 22 and a resistor 24 (the sensed current is the residual AC current, comprising the ripple current sourced by load 14 and the current that power stage 26 sources, as will be described below).

The VIC further comprises a small input capacitor 20, and an output capacitor Cs 30 (also referred to as a buffer capacitor). According to some embodiments, because of the large ripple on the Cs capacitor, Cs capacitor 30 is a film or ceramic type capacitor. The voltage on Cs capacitor 30 is composed of a DC voltage Vsdc, and a smaller AC voltage that is superimposed on the DC voltage. (In further embodiments that are described hereinbelow, the buffer capacitor is incorporated in the power stage.)

As would be appreciated, the structure of VIC 48 described above is cited by way of example. VICs in accordance to the disclosed techniques are not limited to the description hereinabove. In alternative embodiments, for example, although the VIC is a two-terminal device, several extra electrical connections to the VIC may be employed; some may be used for synchronization purposes, other for indication or general control needs. In another example, a different ripple sense network may be used.

In some embodiments according to the present invention, the VIC may employ an over-voltage protection across its input terminals such as a varistor or crowbar circuitry.

Although it is an active device, the VIC mimics a two-terminal passive capacitor, and thus, for example, several VIC devices may be connected in parallel, for increased filtering capacity.

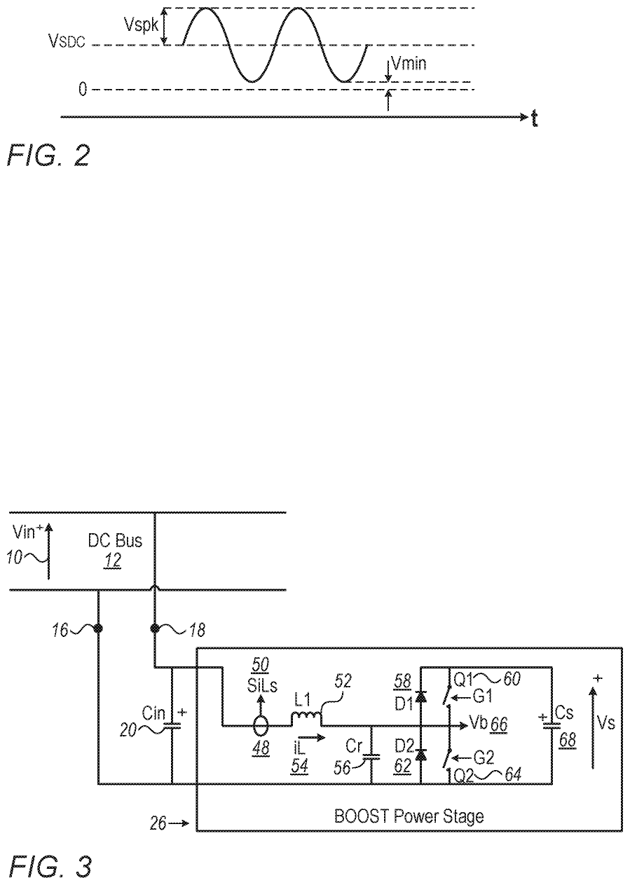

FIG. 2 is a waveform that schematically illustrates the typical voltage across the buffer capacitor Cs in accordance with embodiments of the present invention. According to the example embodiment of FIG. 2, Vspk is smaller than Vsdc by at least Vmin, so that the voltage on Cs is always kept positive above Vmin (by control stage 44, FIG. 1).

FIG. 3 is a circuit diagram that schematically illustrates a boost-type power stage (26) of a VIC, according to embodiments of the present invention. In the example embodiment illustrated in FIG. 3 the input DC bus voltage is lower than the output capacitor voltage

The power stage comprises a current sense terminal 48, an Inductor L1 (52) (the current IL through the inductor is designated 54), a capacitor Cr (56), a Diode D1 (58), a Switch Q1 (60), a Diode D2 (62), a Switch Q2 (64), an output terminal Vb (66) and a buffer capacitor Cs (68). In an embodiment, switches 60 and 64 may be Field Effect Transistors (FETs).

According to the example embodiment illustrated in

FIG. 3, the input DC voltage on DC bus 12, connected to the VIC through its terminals (16, 18), must be lower than the momentary voltage Vcs on the Cs buffer capacitor 68. The inductor current IL is sensed in a current sense terminal 48, that is connected to control stage 44 (FIG. 1) (the current sensor may be, for example, a Hall Effect current sensor). Control Stage 44 uses the sensed current to operate switches Q1 60 and Q2 64, so as to force the inductor current to swing between positive and negative peak values (positive inductor current direction is indicated by the direction of the arrow).

The two switches Q1 60, Q2 64 are alternately connected/disconnected according to the operating conditions by the control stage. The bipolar inductor current enables zero-voltage switching both at turn on and turn off. The control stage 44 turns the power switches on and off with timing chosen so that the average inductor current per switching cycle Ts minimizes the ripple on DC bus 12.

To reduce the ripple on the DC bus, the control circuit measures the momentary residual ripple current on DC bus 12. For that purpose, an R-C network 24-22 (FIG. 1) may be employed. The control circuit generates two current reference values, R+ (positive) and R− (negative). The inductor current is forced by the control stage to oscillate between the average ripple current plus R+ (“ipk+) to the average ripple current plus R− (“ipk−”), so that the average inductor current (per switching cycle Ts) equals the low frequency ripple current imposed by load 14 on input DC voltage 12 (FIG. 1).

Zero voltage switching is achieved both at turn on and turn off. When switch Q2 64 conducts and the input voltage is positive, the inductor current increases until it reaches the peak threshold current ipk+ determined by the control circuit. At this point (or shortly before/after this point), Q2 64 is disconnected, and the inductor current is used to charge Cr 56 and the accumulated parasitic capacitance of the components connected to node Vb. When (or shortly before/after) Vb 66 reaches the Vs voltage, the upper switch 60 is turned on. Consequently, inductor 52 current (54) starts to decline until the inductor current reverses and continues to decline until the current reaches the negative current threshold ipk−, at which point upper switch 60 is disconnected. Consequently, capacitor Cr starts to discharge by the reversed current through the inductor. When Vb 66 reaches zero voltage (or close to it), the lower switch Q2 is connected again for a new switching cycle.

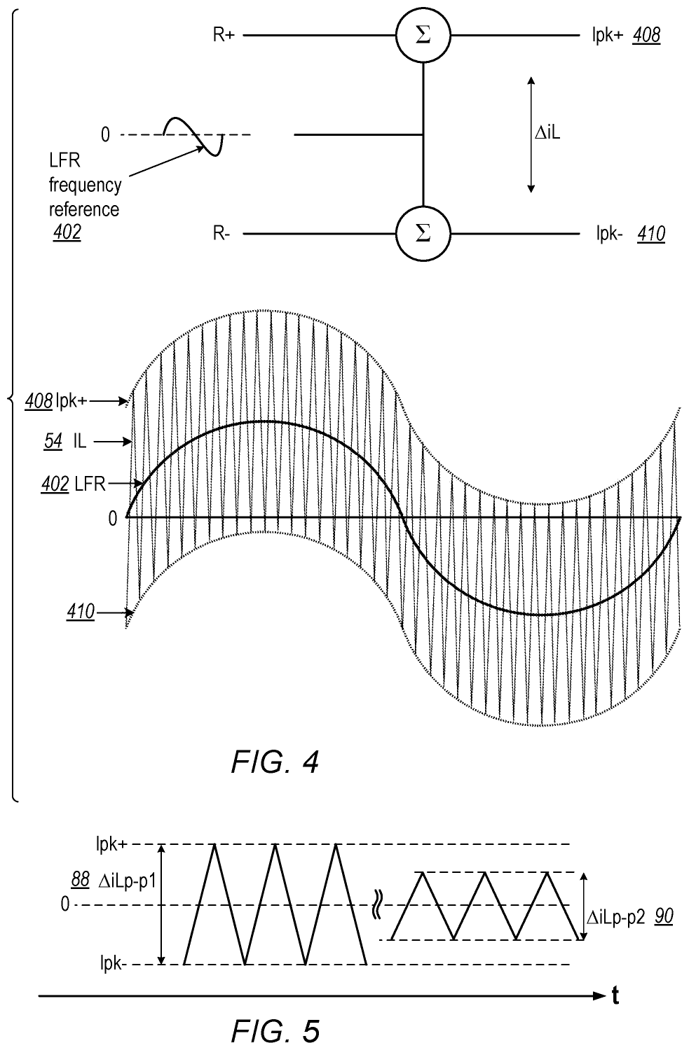

FIG. 4 is a schematic illustration of the waveform of the inductor bipolar current, according to an embodiment of the present invention. According to the working conditions and ripple current measured on DC bus 12, the control derives a Low Frequency Reference (LFR) signal 402. The LFR is added to an R+ positive threshold to generate lpk+ reference, and to an R− negative threshold to generate lpk− signal 410. In some embodiments, R+ and R− have the same absolute value, so that LFR 402 always equal to the average value of lpk+ 408 and lpk− 410. As would be appreciated, since LFR is a low frequency signal and R+, R− are low frequency signals (typically DC voltages), both lpk+ and lpk− are low frequency signals.

Bipolar current 54 comprises alternating positive and negative slopes, wherein, in a positive slope, the current rises from lpk− level 410 to lpk+ level 408, and in a negative slope, the current falls from the lpk+ level to the lpk− level. The frequency of bipolar current 54 is much higher than the frequency of LFR, typically by three orders of magnitude. The desired momentary average inductor current at any point may be achieved just by changing the momentary value of the low frequency reference LFR.

The absolute values of positive threshold voltage R+ and negative threshold voltage R− should be large enough so as to assure that current 54 will be bipolar; in other words, the difference lpk+ minus lpk− (which will be referred to as ΔiLptp) must be larger than the peak-to-peak amplitude of LFR 402. Large values of ΔiLptp, however, result in lower efficiency.

FIG. 5 is a graph that schematically illustrates the controlled peak to peak difference of inductor currents, according to an embodiment of the present invention. In the example embodiment illustrated in FIG. 5, Control Stage 44 may vary R+, and R− in order to change ΔiLp-p. For large induced AC current on the bus by load 14 (FIG. 1) (and consequently large ripple current) a larger ΔiLp-p1 88 may be used, and for low current on the DC bus, a smaller ΔiLp-p2 90 may be used. This may be beneficial for two purposes: 1. Reducing the peak to peak inductor current at working conditions of low ripple current induced on DC bus 12 by load 14, consequently reducing power loss in the power switching stage. 2. Limiting the power switching frequency range for light load and low ripple current on the DC bus.

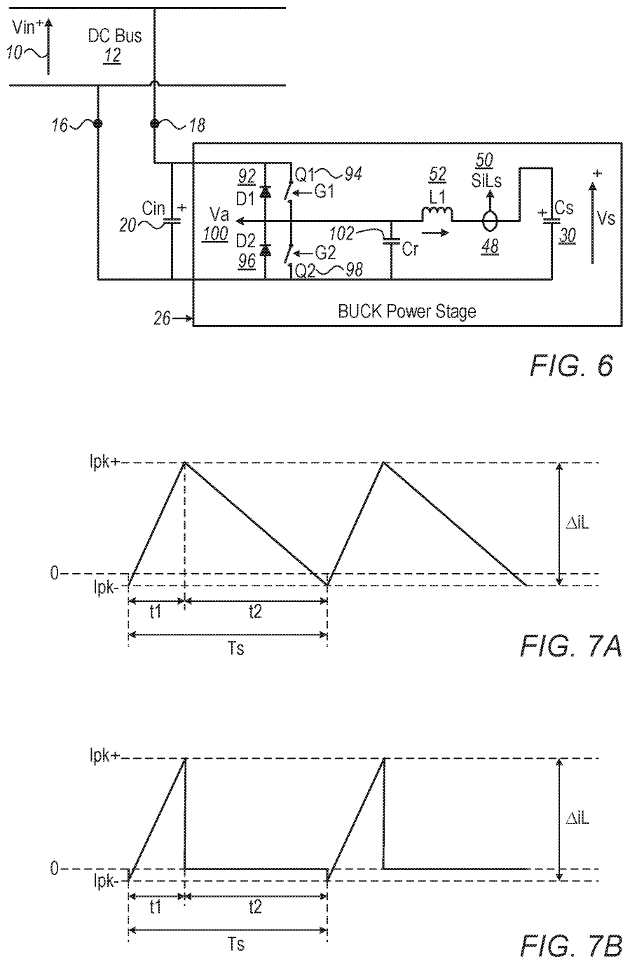

As would be appreciated, although the rising and falling slopes of IL 54 may look symmetric in FIGS. 5, 6, the slopes are determined by the voltage on the inductor and are typically asymmetric. Moreover, as the inductor is not ideal and comprises a resistive component, the slope may not be uniform.

FIG. 6 is a circuit diagram that schematically illustrates a buck-type power stage (26) of a VIC, according to embodiments of the present invention. A buck type power stage may be used where the input voltage is higher than the momentary C_{S} capacitor voltage. Like the power stage shown in FIG. 3, the inductor current alternates between positive and negative currents as shown in FIG. 4 and FIG. 5.

Unlike the power switching topology shown in FIG. 3, which has an input current in the form shown in FIG. 7A, the input current in FIG. 6 is in the shape of a sawtooth as shown in FIG. 7B.

This means that the inductor peak current in FIG. 6, may be higher for the same inductor average current, compared to the power stage shown in FIG. 3.

The inductor current is maintained between a maximum limit and a minimum limit, wherein the maximum limit is positive, and the minimum limit is negative. Due to the bipolar inductor current, zero voltage switching of the power switches 94, 98 is achieved in a similar way to the Boost power stage. The inductor current is used to charge and to discharge Cr 100 capacitor voltage and the accumulated parasitic capacitance of the components connected to node Va 100.

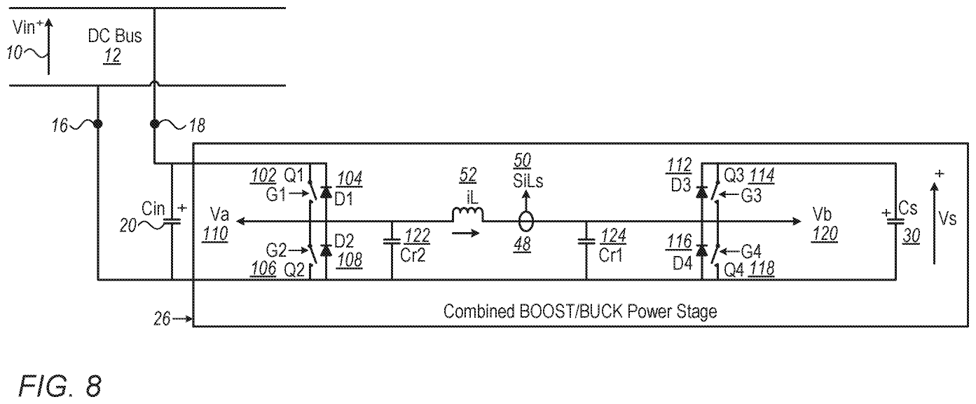

FIG. 8 is a schematic diagram of a Combined Boost-Buck power stage of a VIC, according to an embodiment of the present invention. In the example embodiment illustrated in FIG. 8, the input DC bus voltage may be higher, equal or lower than the buffer capacitor voltage.

The power stage comprises a common inductor L1 (52) and a common buffer-capacitor Cs (30). For bucket-mode operation, the power stage further comprises a switch Q1 102, a diode D1 104, a switch Q2 106, a diode D2 108 and a capacitor Cr2 122. Similarly, for boost-mode operation, the power stage further comprises a diode D3 112, a switch Q3 114, a diode D4 116, a switch Q4 118, and a capacitor Cr1 124.

The power stage illustrated in FIG. 8 may be controlled by the Control Stage to work in one of three operating modes:
1. Boost mode—switches Q3 114 and Q4 118 may be driven on and off alternately, while Q1 102 is constantly driven on, and Q2 106 is constantly off;
2. Buck mode—switches Q1 102 and Q2 106 may be driven on and off alternately, while Q3 114 is constantly driven on, and Q4 118 is constantly off; and
3. Buck-Boost mode—switches Q1 102 and Q4 118 may be driven on for one part of the switching cycle, while Q2 106 and Q3 114 are driven on for the second portion of the switching cycle.

A VIC according to the example embodiment shown in FIG. 8 may change the operating mode of the power stage to one of the three modes described above, depending upon the working conditions. If the input voltage Vin is lower than a threshold value, the VIC may operate in the Boost mode; if Vin 10 is higher than a threshold value, the VIC may operate in the Bucket mode; if Vin changes dynamically and cannot be contained by a threshold, the VIC may operate in the buck-boost mode.

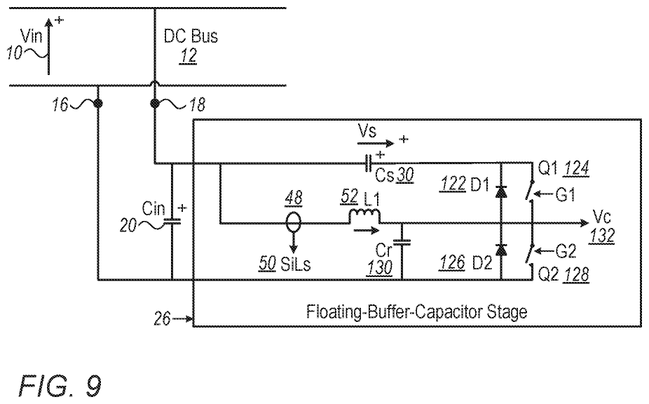

FIG. 9 is a schematic diagram of a Floating Buffer-Capacitor power stage of a VIC, according to an embodiment of the present invention. The power stage comprises a Diode D1 122, a switch Q1 124, a Diode D2 126, a Switch Q2 128 and a capacitor Cr 130. The power stage additionally comprises an inductor L1 52 and a buffer capacitor Cs 30.

According to the example embodiment illustrated in FIG. 9, buffer capacitor Cs 30 is not referenced to the common ground, but rather, connected to the positive terminal of the VIC. As a result, this topology may work well for a wide range of input voltage Vin 10 regardless of the Cs momentary voltage level Vs.

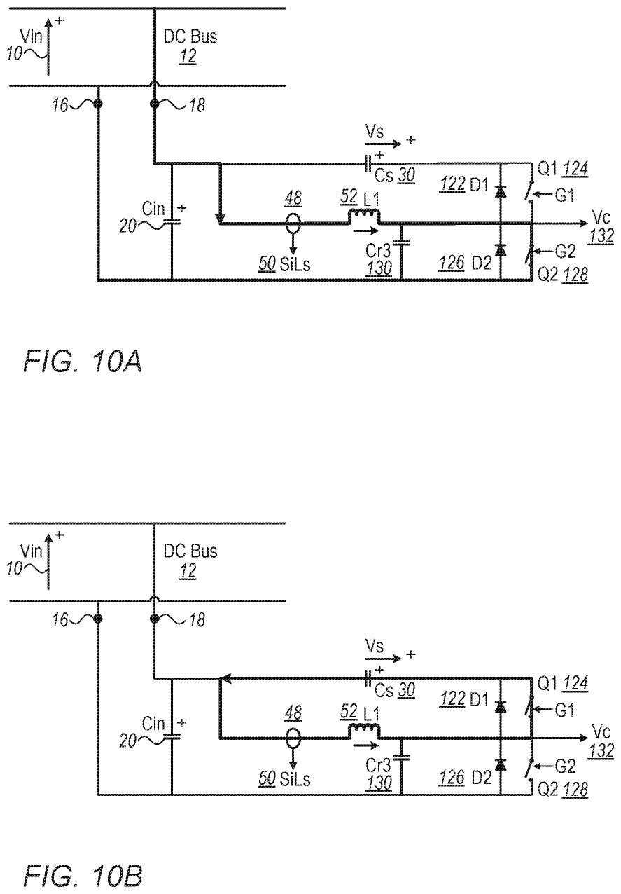

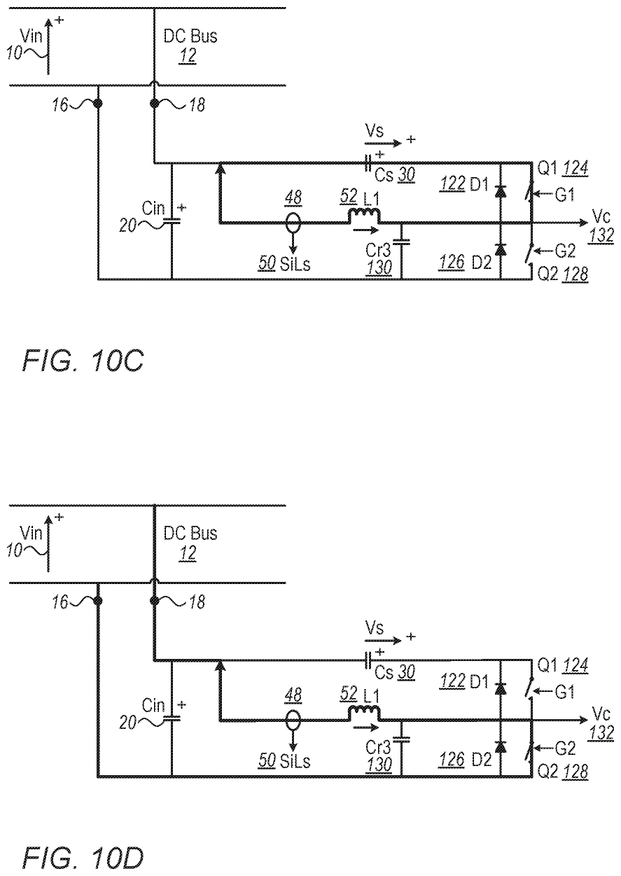

The operation of the Floating-Buffer-Capacitor power circuit will now be described, with reference to FIG. 10A through FIG. 10D. For simplicity of the description, the power switching transition time will not be shown, although there are switching states in which both switches Q1 and Q2 are disconnected.

Depending on the control, there are two main operational states:

1. Drawing current from the DC bus (FIGS. 10A, 10B); and

2. Pushing current to the DC bus (FIGS. 10C, 10D). Each one of the states has a charge phase (FIGS. 10A, 10C) and a discharge phase (FIGS. 10B, 10D). The current path in each of the phases is marked with bold lines.

Zero voltage switching may be achieved for the floating-buffer-capacitor power stage shown in FIG. 9. For this purpose, as described for the power switching stage shown in FIG. 3, the inductor current is used to charge and discharge the voltage on buffer capacitor Cs 30.

Like the former topologies, the control stage in the topology of FIG. 9 may force the inductor current to have a triangular shape, maintained between a positive value ipk+ and a negative value ipk− as shown in FIG. 7A.

As would be appreciated, the structure of the Boost power stage, the Buck power-stage, the Buck-Boost power stage and the floating buffer capacitor power stage illustrated in FIGS. 3, 6, 8, 9 and 10A through 10D, and the corresponding inductor current illustrated in FIGS. 4, 5, 7A and 7B, and described above are cited by way of example. VICs in accordance to the disclosed techniques are not limited to the description hereinabove. In alternative embodiments, for example, other suitable power stages may be used.

Switches G1, G2, G3 and G4 may be for example, MOS transistors, thyristors or optically coupled switches.

As aforementioned, it is desirable that the Cs capacitor voltage have a DC bias over which the AC ripple induced by the power stage is superimposed. In some embodiments, to shorten the initialization period required to charge the Cs capacitor to its Vsdc level, the control stage may drive the power stage at turn-on time in such a way that the Cs capacitor will follow the DC bus voltage. For instance, in the power stage shown in FIG. 8, switches Q1 and Q3 may be connected, while the other switches remain disconnected

Efficient Inductor Structures

In the power switching stages described above, inductor 52 current comprises a large AC component. This may generate large core loss due to hysteresis and eddy currents. Moreover, the inductor may be large and bulky in order to handle high currents.

In another embodiment of the present invention, efficient structures of the inductor, which may be used in any of the power stage embodiments described hereinabove (and in other suitable power stage embodiments according to the present invention) are disclosed.

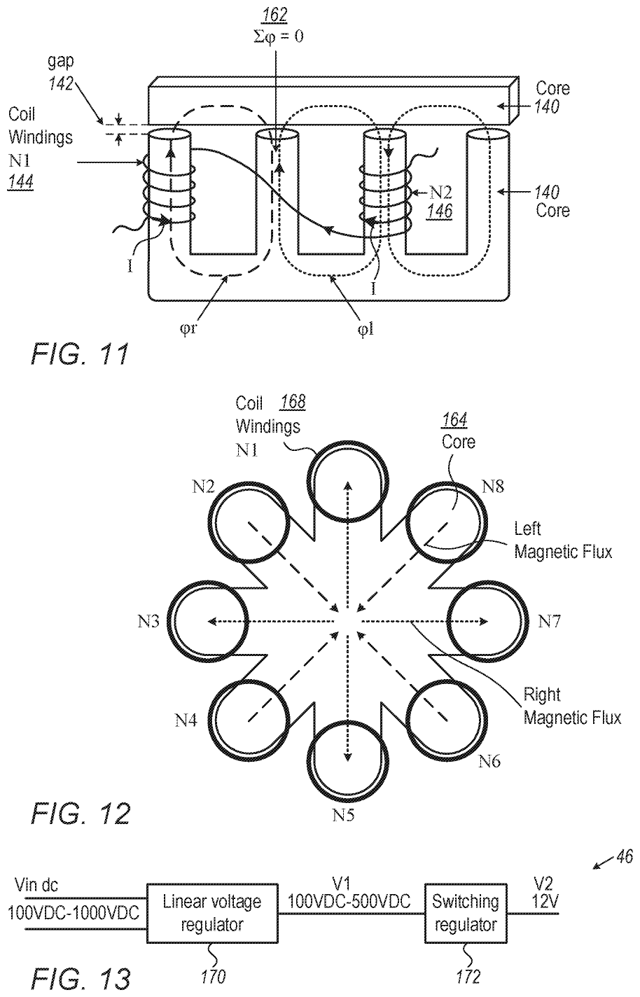

FIG. 11 is a diagram that schematically illustrates a cross-section view of an inductor with two winding groups and core flux cancellation, according to an embodiment of the present invention. The inductor comprises a core 140 with an air gap 142, a coil winding group N1 (144) and a coil winding group N2 (146).

Winding groups N1 and N2 are connected in series, and the current through the windings is designated I. However, as the direction of winding groups N1 and N2 are opposite to each other, the direction of the generated magnetic flux Φr and Φ1 are opposite in the common leg. Since the current that flows through the windings is the same, the number of winding in the two winding groups is the same, the core leg has the same cross section area, and the gap is the same, the generated flux that N1, and

N2 generate have similar momentary amplitude, with opposite directions. This way, the flux at the common leg cancels and the core loss is small.

FIG. 12 is a diagram that schematically illustrates a cross-section view of an inductor with eight winding groups and core flux cancellation, according to an embodiment of the present invention. The inductor comprises a core 164 and winding groups N1 through N8 (168).

Each of the winding groups N1 through N8 is assembled on a separate core leg, but they all share a common return leg which is the central leg. All the windings are connected in series and, therefore, share the same current. The directions of the windings are alternately reversed, meaning N1 is wound in the clockwise direction, N2 is wound counterclockwise, N3 clockwise, etc. Each of the winding groups has the same number of windings, and the corresponding legs have the same physical structure; hence the flux that flows through the central leg cancels out, and, therefore the core loss in the central leg is small.

In some embodiments, the inductors described hereinabove with reference to FIGS. 11, 12 maybe fabricated using integrated planar magnetics and a printed circuit board. In an embodiment, instead or in addition to current sensor 50, the integrated inductor may contain a Hall effect sensor that may be placed within the inductor air gap.

As would be appreciated, the structures of inductor 52 described above are cited by way of example. Inductors in accordance to the disclosed techniques are not limited to the description hereinabove. In alternative embodiments, for example, a suitable inductor with a different number of legs (e.g., 6) may be used; in some embodiments for example, segments of the inductor may be wired in parallel.

Efficient Auxiliary Power Source

In some working conditions, DC Bus 12 voltage may be high (e.g. 1000VDC). An auxiliary power supply connected to the DC bus may be required to supply a lower voltage (e.g., 12VDC) at low power (e.g., 2-3 W) that may be needed by the control stage. Typical switching regulators that handle high input voltage such as 1000 Vdc may be expensive, whereas linear regulators may have very low power efficiency (Vout/Vin).

FIG. 13 is a block diagram that schematically shows the structure of an optional auxiliary power supply 46, according to embodiments of the present invention. The auxiliary power supply comprises a linear regulator 170, connected in series to a switching regulator 172.

Linear Regulator 170 reduces the input voltage to a lower level V₁ at its output. Linear Regulator 170 may be a low drop-out regulator clamped at a voltage such as 500 VDC. When the input voltage is below 500VDC, regulator 170 output V₁ tracks the input voltage. V₁ then feeds switching regulator 172. The switching regulator may have high power switching efficiency, such as 80%. The efficiency of the linear regulator depends on the input voltage and may be close to zero when Vin<=500V, and close to 0.5 when Vin=1000V. Therefore, the overall efficiency of the auxiliary power supply will be close to (e.g., 0.8) when Vin<=500 and close to 0.5 (e.g., 0.4) when Vin=1000V.

As would be appreciated, the structures of the auxiliary power supply 46 described above is cited by way of example. Power supplies in accordance to the disclosed techniques are not limited to the description hereinabove. In alternative embodiments, for example, a switch may be added, shortening regulator 170 when the value of Vin is below a certain threshold.

The circuits which were described hereinabove may be implemented in a variety of ways, including (but not limited to) ASIC, discrete devices, or a combination thereof.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. Apparatus for controlling ripple voltage on a bus, comprising:
a switched power converter, comprising:
a pair of terminals for connection between the bus and a ground;
a buffer capacitor;
an inductor; and
switching circuitry coupled to the buffer capacitor and the inductor and configured to control a voltage between the terminals while a charge on the buffer capacitor varies over a predefined range in response to current flowing through the terminals; and
control circuit, which is configured to adjust the voltage between the terminals by controlling the switching circuitry while maintaining bipolar current flow through the inductor in all working conditions of DC voltage and power flow.

2. The apparatus according to claim 1, wherein the control circuit is configured to control the average current drawn by the power converter per switching cycle by adding a low-frequency voltage reference to both positive and negative current thresholds ipk+ and ipk− that are applied to the current flow through the inductor.

3. The apparatus according to claim 2, wherein the control circuit is configured to adjust a difference Δi between ipk+ and ipk− so as to reduce power loss in the power converter for low power flow conditions.

4. The apparatus according to claim 2, wherein the control circuit is configured to adjust a difference Δi between ipk+ and ipk− so as to control a variation range of a switching frequency of the power converter.

5. The apparatus according to claim 1, wherein the switching circuitry is configured to operate in both buck and boost modes, and the control circuit is configured to select an operating mode of the switching circuitry responsively to a level of the voltage, so as to maintain the current flow through the inductor within a desired range.

6. The apparatus according to claim 1, wherein the inductor comprises a core having a plurality of windings arranged thereon in series so as to cancel a flux of a magnetic field within the core.

7. The apparatus according to claim 6, and comprising a Hall effect sensor coupled to the core and configured to output a signal in response the magnetic field wherein the control circuit is configured to estimate and control the current flow through the inductor responsively to the signal.

8. Apparatus for controlling ripple voltage on a bus, comprising:
a switched power converter, comprising:
a pair of terminals for connection between the bus and a ground;
a buffer capacitor; and
switching circuitry coupled to the buffer capacitor and configured to control a voltage between the terminals while a charge on the buffer capacitor varies over a predefined range in response to a current flowing through the terminals; and
a control circuit, which is configured to adjust the voltage between the terminals by controlling the switching circuitry while maintaining a DC voltage level on the buffer capacitor sufficient so that a total voltage across the buffer capacitor remains in a positive range while an AC component of the total voltage varies in order to cancel a ripple on the bus.

9. The apparatus according to claim 8, wherein the control circuit is configured to operate the switching circuitry so as to connect the buffer capacitor to the bus until the buffer capacitor has charged to the sufficient DC voltage level.

10. An apparatus for controlling ripple voltage on a bus, comprising:
a switched power converter, comprising:
a pair of terminals for connection between the bus and a ground;
a floating buffer capacitor not coupled to ground;
an inductor;
switching circuitry coupled to the buffer capacitor and the inductor; and
a control circuit, which is configured to adjust the voltage between the terminals by controlling the switching circuitry.

11. The apparatus according to claim 10, wherein the floating buffer capacitor is coupled directly to a first terminal of the inductor, and through a switch of the switching circuitry to a second terminal of the inductor.

12. Apparatus for controlling ripple voltage on a bus, comprising:
a switched power converter, comprising:
a pair of terminals for connection between the bus and a ground;
a buffer capacitor; and
switching circuitry coupled to the buffer capacitor and configured to control a voltage between the terminals while a charge on the buffer capacitor varies over a predefined range in response to a current flowing through the terminals;
a control circuit, which is configured to adjust the voltage between the terminals by controlling the switching circuitry; and
an auxiliary power supply, comprising a linear regulator, which is connected to the bus and configured to reduce the DC voltage on the bus to a predefined intermediate voltage, and a switching regulator, which is configured to convert the intermediate voltage to a predefined low DC voltage for powering the switching circuitry and the control circuit.
